(19) United States
(12) Patent Application Publication
(10) Pub. No.: US 2016/0172968 A1
(43) Pub. Date: Jun. 16, 2016

(54) COMPENSATION CONTROL CIRCUIT AND METHOD THEREOF

(71) Applicants: MING-FENG LIN, Taichung City (TW); HEP TECH CO., LTD., Taichung City (TW)

(72) Inventor: MING-FENG LIN, Taichung City (TW)

(21) Appl. No.: 14/965,150

(22) Filed: Dec. 10, 2015

(30) Foreign Application Priority Data
Dec. 12, 2014 (TW) 103143551

(51) Int. Cl. H02M 3/04

(52) U.S. Cl. CPC H02M 3/04

(57) ABSTRACT

A compensation control circuit is provided, which may be connected to a converter to compensate its error. The compensation control circuit may include a compensation control module, a control module and a modulation module. The compensation control module may include a compensation control port, and the compensation control module can receive a compensation database via the compensation control port and then output a compensation signal corresponding to the compensation database. The compensation database can be created by pre-measurement, which may include the compensation signal corresponding to the error that will occur on the converter under a specific input power signal. The control module can output a control signal according to the compensation signal. The modulation module can modulate the control signal into a modulation signal and output the modulation signal to the converter so as to control the output signal of the converter.

### CROSS REFERENCE TO RELATED APPLICATION

All related applications are incorporated by reference. The present application is based on, and claims priority from, Taiwan Application Serial Number 103143551, filed on Dec. 12, 2014, the disclosure of which is hereby incorporated by reference herein in its entirety.

### TECHNICAL FIELD

The technical field relates to a compensation control circuit, in particular to a compensation control circuit capable of effectively compensating for the errors of a converter. The technical field further relates to the compensation control method of the compensation control circuit.

### BACKGROUND

In general, a power supply should, in real time, measure the feedback signal generated from a converter when the converter is in operation, and then estimate a compensation signal needed by the output signal of the converter according to the feedback signal so as to compensate the error of the output signal of the converter; accordingly, the power supply should have additional detector circuit and feedback circuit in order to execute the above compensation mechanism, which will directly increase the cost of the power supply. Besides, the above compensation mechanism should estimate the compensation signal according to the feedback signal; however, the estimated compensation signal cannot precisely compensate the error of the output signal of the converter; accordingly, the performance of the conventional compensation control circuit still needs to be further improved.

U.S. Pat. No. 6,707,283 discloses a compensation control circuit applied to switching power supply, which can, in real time, measure the feedback signal generated from the secondary side of a transformer to generate a real-time compensation signal so as to compensate for the error of the output signal. However, as described above, the mechanism needs additional detection circuit and feedback circuit, which will increase the cost of the compensation control circuit. Besides, the compensation control circuit should, in real time, measure the feedback signal generated from the secondary side of the transformer to generate the real-time compensation signal when the power supply is in operation; however, the estimated compensation signal cannot precisely compensate for the error of the output signal; thus, the compensation control circuit cannot achieve high performance. Other conventional compensation control circuits also have similar problems.

Further, certain application needs to use an output signal with special waveform instead of the frequently-used constant-current mode or constant-voltage mode; however, the conventional compensation control circuit cannot precisely generate an output signal with special waveform, which limits the application range of the conventional compensation control circuit.

Therefore, it has become an important issue to provide a compensation circuit capable of improving the shortcomings that the conventional compensation control circuit is of high cost, low performance and not flexible in use.

### SUMMARY

One of the primary objects of the present disclosure is to provide a compensation control circuit and the method thereof so as to improve the shortcomings that the conventional compensation control circuit is of high cost, low performance and not flexible in use.

A compensation control circuit is provided to achieve the foregoing objective, which may include a compensation control module, a control module and a modulation module. The compensation control module may include a compensation control port; the compensation control module may be configured to receive a feedback signal and receive a compensation database via the compensation control port so as to compare the feedback signal with the compensation database and then output a compensation signal corresponding to the feedback signal according to a comparison result. The control module may be configured to output a control signal according to the compensation signal. The modulation module may be configured to convert the control signal into a modulation signal, and output the modulation signal to a converter so as to control the converter's output signal outputted to a load.

In a preferred embodiment of the present disclosure, the compensation control module may receive the feedback signal from a power source.

In a preferred embodiment of the present disclosure, the compensation control module may receive the feedback signal from the converter.

In a preferred embodiment of the present disclosure, the compensation database may be created by a pre-measurement process; the compensation database may include the compensation signals corresponding to the errors that will occur on the converter under different input power signals.

In a preferred embodiment of the present disclosure, the converter may be an isolated converter.

In a preferred embodiment of the present disclosure, the modulation module may be a pulse width modulation controller.

In a preferred embodiment of the present disclosure, the load may be a lighting device, an electronic device or a household appliance.

In a preferred embodiment of the present disclosure, the compensation control port may be a RS232 port.

In a preferred embodiment of the present disclosure, the mode of the output signal may be the constant-current output mode, the constant-voltage output mode, the constant-power output mode, the irregular-current output mode, the irregular-voltage output mode or the irregular-power output mode.

In a preferred embodiment of the present disclosure, the compensation database may be inputted into the compensation control port via digital signal.

A compensation control method is provided to achieve the foregoing objective, which may include the following steps: creating a compensation database; receiving a feedback signal; comparing the feedback signal with the compensation database to generate a compensation signal corresponding to the feedback signal according to the comparison result; generating a control signal according to the compensation signal; and converting the control signal into a modulation signal, and outputting the modulation signal to a converter so as to control the converter's output signal outputted to a load.

In a preferred embodiment of the present disclosure, the compensation control method may further include the following step: receiving the feedback signal from a power source.

In a preferred embodiment of the present disclosure, the compensation control method may further include the following step: receiving the feedback signal from the converter.

In a preferred embodiment of the present disclosure, the compensation control method may further include the following step: measuring the compensation signals corresponding to the errors that will occur on the converter under different input power signals by a pre-measurement process so as to create the compensation database.

In a preferred embodiment of the present disclosure, the compensation control method may further include the following step: controlling the mode of the output signal to be the constant-current output mode, the constant-voltage output mode, the constant-power output mode, the irregular-current output mode, the irregular-voltage output mode or the irregular-power output mode via the modulation signal.

In a preferred embodiment of the present disclosure, the compensation control method may further include the following step: inputting the compensation database into the compensation control port via digital signal.

A compensation control circuit is provided to achieve the foregoing objective, which may include a compensation control module, a control module and a modulation module. The compensation control module may include a compensation control port; the compensation control module may be configured to receive a compensation database via the compensation control port so as to output a compensation signal according to the comparison result. The control module may be configured to output a control signal according to the compensation signal. The modulation module may be configured to convert the control signal into a modulation signal, and output the modulation signal to a converter so as to control the converter's output signal outputted to a load.

In a preferred embodiment of the present disclosure, the compensation database may be created by a pre-measurement process; the compensation database may include the compensation signal corresponding to the error that will occur on the converter under a specific input power signal.

In a preferred embodiment of the present disclosure, the compensation database may include a setting value, and the compensation database may generate the compensation signal corresponding to the setting value so as to adjust the output signal of the converter to be close to a pre-determined specification value.

In a preferred embodiment of the present disclosure, the compensation database may further include a compensation value, and the compensation value may be measured via a pre-measurement process; the compensation control module may regenerate the compensation signal corresponding to the compensation value so as to compensate the error between the output signal of the converter and the pre-determined specification value.

In a preferred embodiment of the present disclosure, the converter may be an isolated converter.

In a preferred embodiment of the present disclosure, the modulation module may be a pulse width modulation controller.

In a preferred embodiment of the present disclosure, the load may be a lighting device, an electronic device or a household appliance.

In a preferred embodiment of the present disclosure, the compensation control port may be a RS232 port.

In a preferred embodiment of the present disclosure, the mode of the output signal may be the constant-current output mode, the constant-voltage output mode, the constant-power output mode, the irregular-current output mode, the irregular-voltage output mode or the irregular-power output mode.

In a preferred embodiment of the present disclosure, the compensation database may be inputted into the compensation control port via digital signal.

A compensation control method is provided to achieve the foregoing objective, which may include the following steps: creating a compensation database; generating a compensation signal according to the compensation database; generating a control signal according to the compensation signal; and converting the control signal into a modulation signal, and outputting the modulation signal to a converter so as to control the converter's output signal outputted to a load.

In a preferred embodiment of the present disclosure, the compensation control method may further include the following step: measuring the compensation signal corresponding to the error that will occur on the converter under a specific input power signal via a pre-measurement process so as to create the compensation database.

In a preferred embodiment of the present disclosure, the compensation control method may further include the following step: generating the compensation signal corresponding to a setting value of the compensation database so as to adjust the output signal of the converter to be close to a pre-determined specification value.

In a preferred embodiment of the present disclosure, the compensation control method may further include the following step: measuring the error between the output signal of the converter and the pre-determined specification value so as to create a compensation value in the compensation database, and regenerating the compensation signal corresponding to the compensation value so as to compensate the error between the output signal of the converter and the pre-determined specification value.

In a preferred embodiment of the present disclosure, the compensation control method may further include the following step: controlling the mode of the output signal to be the constant-current output mode, the constant-voltage output mode, the constant-power output mode, the irregular-current output mode, the irregular-voltage output mode or the irregular-power output mode via the modulation signal.

In a preferred embodiment of the present disclosure, the compensation control method may further include the following step: inputting the compensation database into the compensation control port via digital signal.

The compensation control circuit and the method according to the exemplary embodiments of the present disclosure may have the following advantages:

(1)According to one embodiment of the present disclosure, the compensation control circuit can obtain the compensation signal needed by the converter under a specific input power signal via the compensation database created by the pre-measurement process, which can accurately compensate for the error of the converter; therefore, the performance of the compensation control circuit can be significantly improved.

(2)According to one embodiment of the present disclosure, the compensation control circuit can compensate for the error of the converter in advance via the pre-calibration process, so the compensation control circuit does not need to receive a feedback signal; therefore, the compensation control circuit does not need additional detection circuit and additional feedback circuit, which can significantly reduce the cost of the compensation control circuit.

(3)According to one embodiment of the present disclosure, the compensation control circuit can generate various output signal waveforms, so the compensation control circuit can satisfy the requirements of various special applications; thus, the compensation control circuit is more comprehensive in use.

(4)According to one embodiment of the present disclosure, the compensation control circuit can obtain the compensation signals needed by the converter under different input power signals via the compensation database created by the pre-measurement process, and compare the feedback signal of the power supply with the compensation database to generate the corresponding compensation signal by the pre-calculation process; in this way, the compensation control circuit can more precisely compensate for the error of the converter; therefore, the compensation control circuit is more practical in use.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a first schematic view of a first embodiment of a compensation control circuit in accordance with the present disclosure.

FIG. 2 is a second schematic view of a first embodiment of a compensation control circuit in accordance with the present disclosure.

FIG. 3 is a third schematic view of a first embodiment of a compensation control circuit in accordance with the present disclosure.

FIG. 4 is a fourth schematic view of a first embodiment of a compensation control circuit in accordance with the present disclosure.

FIG. 5 is a fifth schematic view of a first embodiment of a compensation control circuit in accordance with the present disclosure.

FIG. 6 is a flowchart view of a first embodiment of a compensation control circuit in accordance with the present disclosure.

FIG. 7 is a schematic view of a second embodiment of a compensation control circuit in accordance with the present disclosure.

FIG. 8 is a flowchart view of a second embodiment of a compensation control circuit in accordance with the present disclosure.

FIG. 9 is a first schematic view of a third embodiment of a compensation control circuit in accordance with the present disclosure.

FIG. 10 is a second schematic view of a third embodiment of a compensation control circuit in accordance with the present disclosure.

FIG. 11 is a flowchart view of a third embodiment of a compensation control circuit in accordance with the present disclosure.

FIG. 12 is a first schematic view of a fourth embodiment of a compensation control circuit in accordance with the present disclosure.

FIG. 13 is a second schematic view of a fourth embodiment of a compensation control circuit in accordance with the present disclosure.

FIG. 14 is a flowchart view of a fourth embodiment of a compensation control circuit in accordance with the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

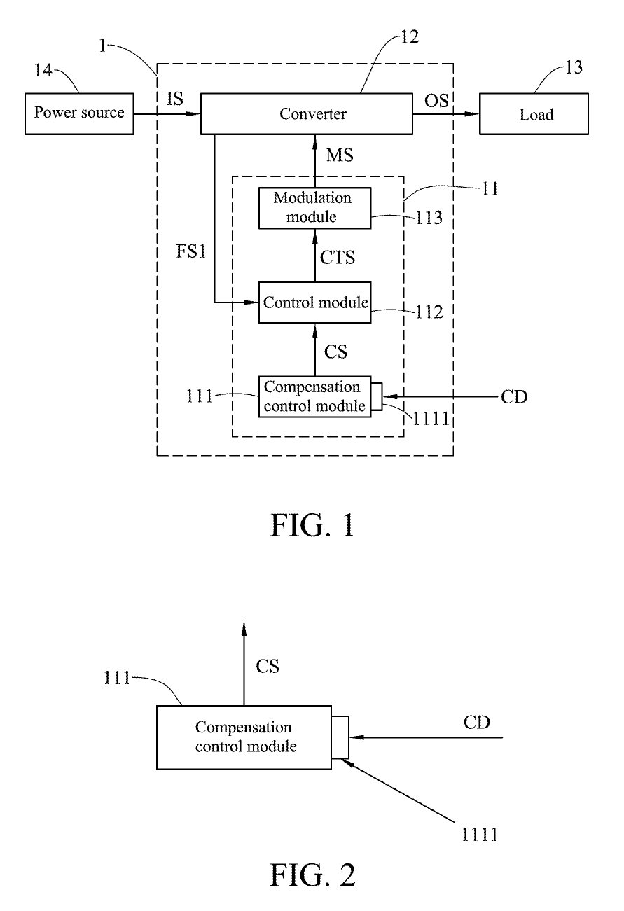

Please refer to FIG. 1 and FIG. 2, which are a first schematic view and a second schematic view of a first embodiment of a compensation control circuit in accordance with the present disclosure. As shown in FIG. 1, the power supply 1 may include a compensation control circuit 11 and a converter 12; the compensation control circuit 11 may include a compensation control module 111, a control module 112 and a modulation module 113.

The converter 12 may convert the input power signal IS of a power source 14 into an output signal OS and then output the output signal OS to a load 13. As shown in FIG. 2, the compensation control module 111 may include a compensation control port 1111; the compensation control module 111 may receive a compensation database CD from the compensation control port 1111 and then output a corresponding compensation signal CS according to the compensation database CD; the compensation control port 1111 may be, for example, a RS232 port or the like. As shown in FIG. 1, the control module 112 may output a control signal CTS according to the compensation signal CS and a feedback signal FS1. The modulation module 113 may convert the control signal CTS into a modulation signal MS and output the modulation signal MS to the converter 12 so as to control the converter 12's output signal OS outputted to the load 13; the converter 12 may be, for example, an isolated converter or the like.

More specifically, the compensation database CD may be created via a pre-measurement process; for instance, a user may use a multi-meter, or the like, to measure the error of the output signal OS of the converter 12 under a specific input power signal IS so as to calculate the compensation signal CS corresponding to the error of the output signal OS of the converter 12, and then create the compensation database CD; next, the user may input the compensation database CD into the compensation control module 111 via the compensation control port 111. In this way, when the power supply 1 is in operation, the compensation control module 111 may directly generate the corresponding compensation signal CS according to the compensation database CD rather than generate the compensation signal CS by receiving the real-time feedback signal.

Since the compensation control module 111 can generate the compensation signal CS without feedback signal, so the cost of the additional detection circuit and feedback circuit can be saved; accordingly, the cost of the compensation control module 111 can be significantly reduced. Moreover, the user can directly use the multi-meter to more precisely measure the error of the output signal OS of the converter 12 under the specific input power signal IS, and accurately calculate the compensation signal CS corresponding to the error of the output signal OS of the converter 12. As described above, according to the embodiment, all products can be accurately calibrated via the above pre-calibration process before being used; in this way, the performance of all products can be significantly improved when being used.

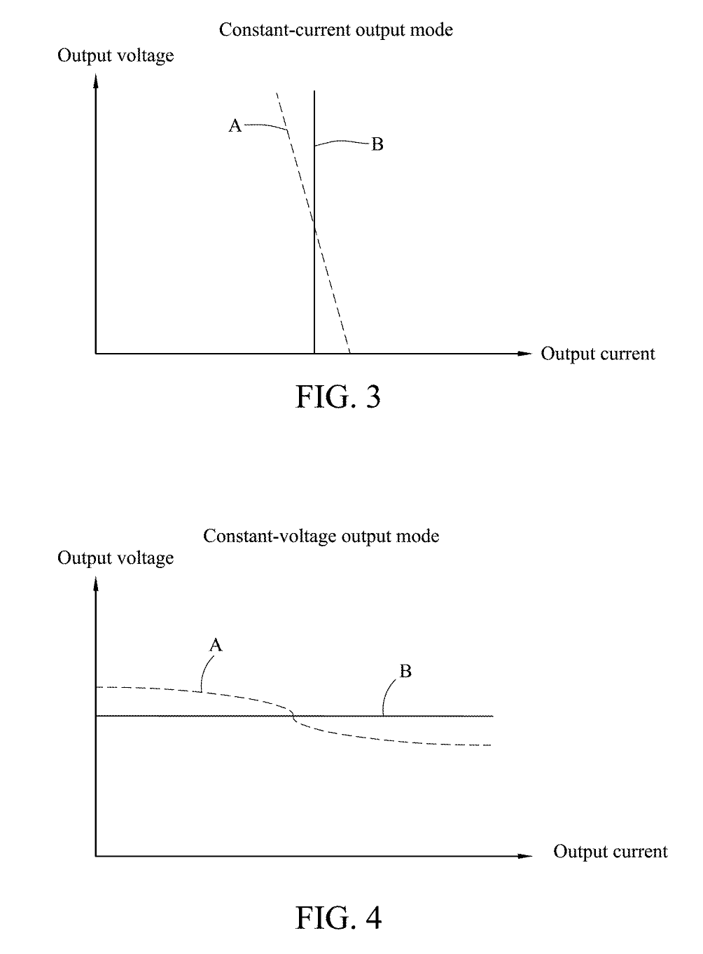

Please refer to FIG. 3, which is a third schematic view of a first embodiment of a compensation control circuit in accordance with the present disclosure. As described above, the compensation database CD can be created by the pre-measurement process; in other words, the user can directly measure the error of the output signal OS of the converter 12 under the specific input power signal IS via a multi-meter or the like.

When the user needs to make the converter 12 be operated under the constant-current output mode, the user can measure the output current curve of the converter 12 under the specific input power signal IS via the pre-measurement process so as to calibrate the converter 12. As shown in FIG. 3, the curve A is the real output current curve of the converter 12 under the specific input power signal IS, which can be measured by the pre-measurement process; the curve B is the ideal output current curve; therefore, the difference between the curve A and the curve B can be obtained via the pre-measurement process to obtain the compensation value corresponding to the difference in order to create the compensation database CD; then, the compensation database CD can be inputted into the compensation control module 111 via digital signal. By means of the above method, the compensation control module 111 can generate the corresponding compensation signal CD according to the compensation database CD so as to precisely compensate for the error of the converter 12 to make the converter 12 be operated under the constant-current output mode.

Please refer to FIG. 4, which is a fourth schematic view of a first embodiment of a compensation control circuit in accordance with the present disclosure. Similarly, when the user needs to make the converter 12 be operated under the constant-voltage output mode, the user can measure the output voltage curve of the converter 12 under the specific input power signal IS via the pre-measurement process so as to calibrate the converter 12.

As shown in FIG. 4, the curve A is the real output voltage curve of the converter 12 under the specific input power signal IS, which can be measured by the pre-measurement process; the curve B is the ideal output voltage curve; therefore, the difference between the curve A and the curve B can be obtained via the pre-measurement process to obtain the compensation value corresponding to the difference in order to create the compensation database CD; then, the compensation database CD can be inputted into the compensation control module 111 via digital signal. By means of the above method, the compensation control module 111 can generate the corresponding compensation signal CD according to the compensation database CD so as to precisely compensate for the error of the converter 12 to make the converter 12 be operated under the constant-voltage output mode.

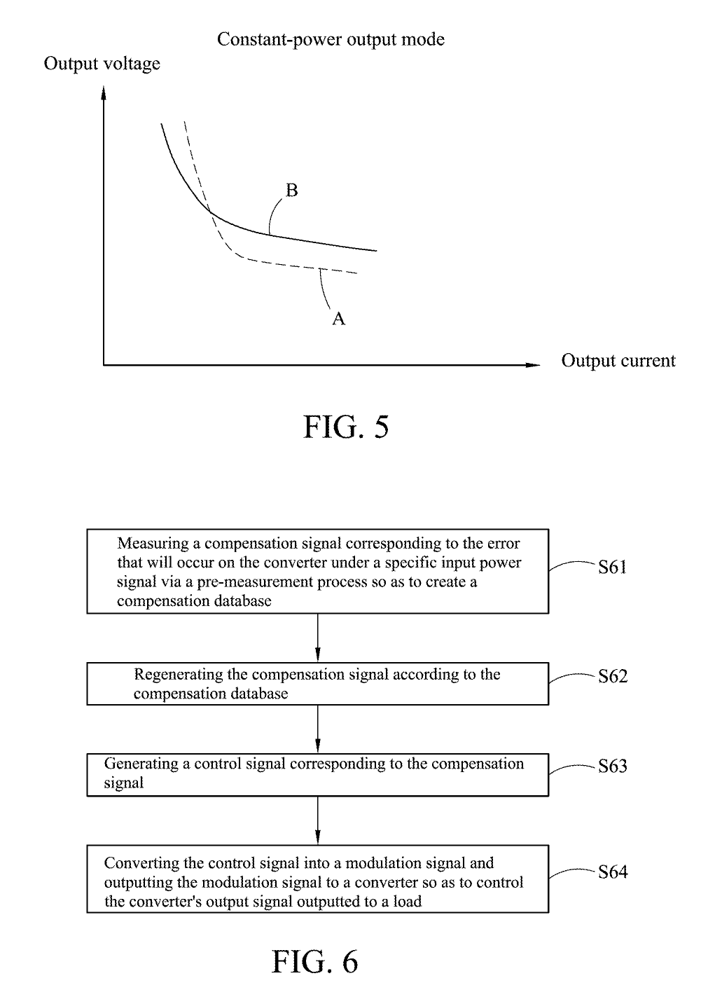

Please refer to FIG. 5, which is a fifth schematic view of a first embodiment of a compensation control circuit in accordance with the present disclosure. Similarly, when the user needs to make the converter 12 be operated under the constant-power output mode, the user can measure the output power curve of the converter 12 under the specific input power signal IS via the pre-measurement process so as to calibrate the converter 12.

As shown in FIG. 5, the curve A is the real output power curve of the converter 12 under the specific input power signal IS, which can be measured by the pre-measurement process; the curve B is the ideal output power curve; therefore, the difference between the curve A and the curve B can be obtained via the pre-measurement process to obtain the compensation value corresponding to the difference in order to create the compensation database CD; then, the compensation database CD can be inputted into the compensation control module 111 via digital signal. By means of the above method, the compensation control module 111 can generate the corresponding compensation signal CD according to the compensation database CD so as to precisely compensate for the error of the converter 12 to make the converter 12 be operated under the constant-power output mode.

On the other hand, some special applications need special irregular output curves instead of the above modes. However, by means of the above method, the compensation control circuit 11 can also precisely make the converter 12 be operated under the irregular-current output mode, irregular-voltage output mode and irregular-power output mode; therefore, the compensation control circuit 11 can output irregular output curves, so the application range of the compensation control circuit 11 can be more comprehensive. The above circuit designs can be applied to various kinds of loads, such as lighting devices, various electronic devices or household appliances, etc.

It is worthy to point out that a conventional compensation control circuit should estimate the compensation signal in real time via a feedback signal so as to compensate for the error of the output signal of the converter, so the conventional compensation control circuit needs additional detection circuit and feedback circuit; therefore, the cost of the conventional compensation control circuit will be significantly increased. On the contrary, according to one embodiment of the present disclosure, the compensation control circuit can compensate for the error of the output signal of the converter without feedback signal; therefore, the compensation control circuit does not need additional detection circuit and feedback circuit; therefore, the cost of the compensation control circuit can be significantly reduced.

Also, the conventional compensation control circuit should indirectly estimate the compensation signal via the feedback signal so as to compensate for the error of the output signal of the converter; therefore, the conventional compensation control circuit cannot achieve high precision, which will significantly influence its performance On the contrary, according to one embodiment of the present disclosure, the compensation control circuit can directly measure the error between the output signal of the converter and the ideal value by the pre-measurement process, which can use a multi-meter or the like to directly measure the error between the output signal of the converter and the ideal value; therefore, the compensation control circuit can achieve high precision and better performance.

Furthermore, the conventional compensation control circuit cannot precisely make a power supply generate an output signal with special waveform, which will significantly limit its application range. On the contrary, according to one embodiment of the present disclosure, the compensation control circuit can generate various different or irregular output signal waveforms, so the compensation control circuit can satisfy the requirements of various special applications; therefore, the application range of the compensation control circuit can be more comprehensive.

Please refer to FIG. 6, which is a flowchart view of a first embodiment of a compensation control circuit in accordance with the present disclosure. The embodiment may include the following steps:

In the step S61: measuring a compensation signal corresponding to the error that will occur on the converter under a specific input power signal via a pre-measurement process so as to create a compensation database.

In the step S62: regenerating the compensation signal according to the compensation database.

In the step S63: generating a control signal corresponding to the compensation signal.

In the step S64: converting the control signal into a modulation signal and outputting the modulation signal to a converter so as to control the converter's output signal outputted to a load.

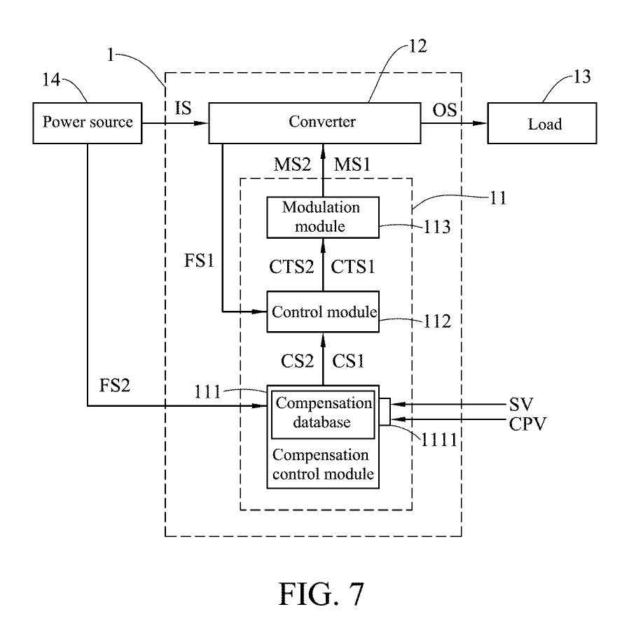

Please refer to FIG. 7, which are a schematic view of a second embodiment of a compensation control circuit in accordance with the present disclosure. As shown in FIG. 7, the power supply 1 may include a compensation control circuit 11 and a converter 12; the compensation control circuit 11 may include a compensation control module 111, a control module 112 and a modulation module 113.

The difference between the embodiment and the previous embodiment is that the converter 12 can be, before the pre-calibration process, pre-set to be operated under a specific specification value in the embodiment. For example, the specification range of the converter 12 may be, for example, constant-current (CC): 400-700 mA, constant-voltage (CV): 3.5V-6V or constant-power (CP): 31-40 W, etc.; the specification value of the converter 12 can be pre-set to be operated under a specific specification value before further calibration.

For instance, when it is required to make the converter 12 be operated under a specific constant-current specification value: 500 mA, a setting value SV, which may be a digital signal, can be inputted into the compensation control module 111 via the compensation control port 1111 to serve as the compensation database CD; the compensation control module 111 may output a compensation signal CS1 corresponding to the setting value SV; the control module 112 may output a control signal CTS1 according to the compensation signal CS1; the modulation module 113 may convert the control signal CTS1 into a modulation signal MS1 and output the modulation signal MS1 to the converter 12 so as to control the converter 12's output signal OS outputted to a load 13 to be the constant-current value: 500 mA.

However, there may be still an error between the output signal OS of the converter 12 and the above constant-current specification value; therefore, the pre-measurement process may be conducted to measure the error between the output signal OS of the converter 12 and the above constant-current specification value so as to calculate a compensation value CPV; the compensation value CPV, which may be a digital signal, may be inputted into the compensation control module 111 via the compensation control port 1111 to server as the compensation database CD; the compensation control module 111 may output a compensation signal CS2 corresponding to the compensation value SV; the control module 112 may output a control signal CTS2 according to the compensation signal CS2; the modulation module 113 may convert the control signal CTS2 into a modulation signal MS2 and output the modulation signal MS2 to the converter 12 so as to compensate for the error between the output signal OS of the converter 12 and the above constant-current specification value.

According to the above method, the converter 12 may be pre-set to be operated under a specific specification value to make the converter 12 drive the load 13 by the specific specification value, and the error may be measured by the pre-measurement process; finally, the compensation value CPV, which may be a digital signal, may be inputted into compensation control module 111 to compensate for the above error so as to increase the precision of the circuit.

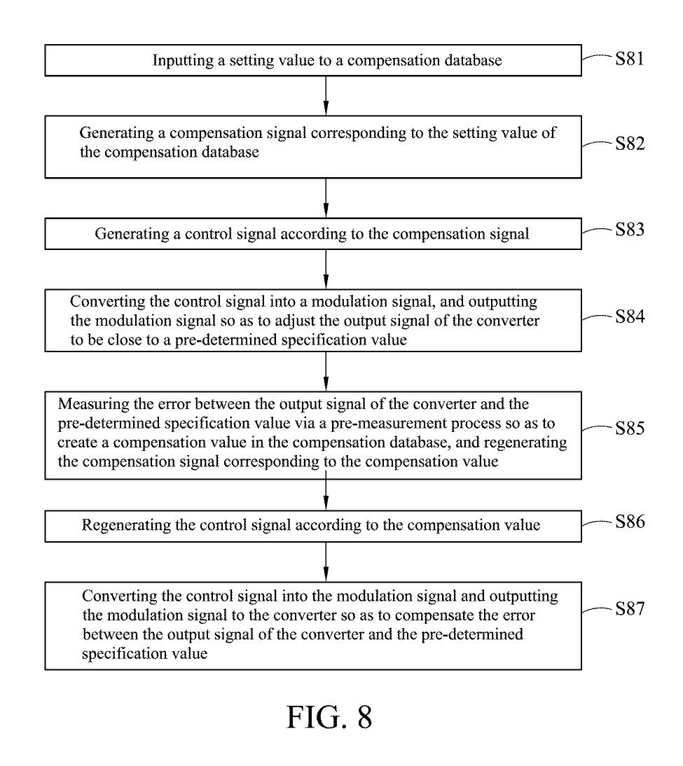

Please refer to FIG. 8, which is a flowchart view of a second embodiment of a compensation control circuit in accordance with the present disclosure. The embodiment may include the following steps:

In the step S81: inputting a setting value to a compensation database.

In the step S82: generating a compensation signal corresponding to the setting value of the compensation database.

In the step S83: generating a control signal according to the compensation signal.

In the step S84: converting the control signal into a modulation signal, and outputting the modulation signal so as to adjust the output signal of the converter to be close to a pre-determined specification value.

In the step S85: measuring the error between the output signal of the converter and the pre-determined specification value via a pre-measurement process so as to create a compensation value in the compensation database, and regenerating the compensation signal corresponding to the compensation value.

In the step S86: regenerating the control signal according to the compensation value.

In the step S87: converting the control signal into the modulation signal and outputting the modulation signal to the converter so as to compensate the error between the output signal of the converter and the pre-determined specification value.

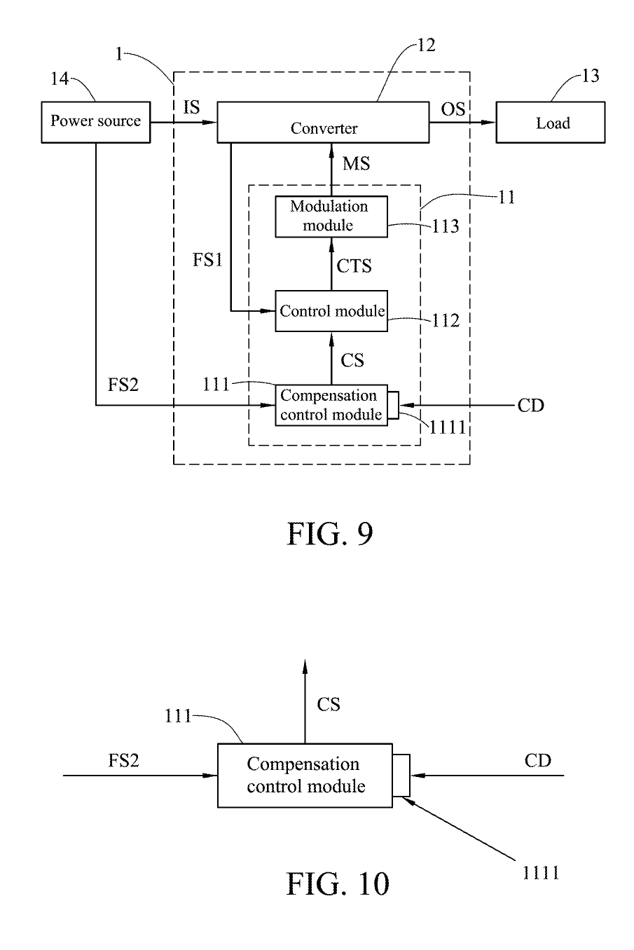

Please refer to FIG. 9 and FIG. 10, which are a first schematic view and a second schematic view of a third embodiment of a compensation control circuit in accordance with the present disclosure. For the purpose of increasing the precision of the compensation control circuit 11, the compensation control circuit 11 may calibrate the error via a feedback signal. As shown in FIG. 9, the power supply 1 may include a compensation control circuit 11 and a converter 12; the compensation control circuit 11 may include a compensation control module 111, a control module 112 and a modulation module 113.

The converter 12 may convert the input power signal IS of a power source 14 into an output signal OS and then output the output signal OS to a load 13. As shown in FIG. 10, the compensation control module 111 may include a compensation control port 1111; the compensation control module 111 may receive a feedback signal FS2 from a power source 14 and receive a compensation database CD via the compensation control port 1111; the compensation control module 111 may compare the feedback signal FS2 with the compensation database CD and output a compensation signal CS according to the comparison result. As shown in FIG. 9, the control module 112 may output a control signal CTS according to the compensation signal CS and a feedback signal FS1. The modulation module 113 may convert the control signal CTS into a modulation signal MS and output the modulation signal MS to the converter 12 so as to control the converter 12's output signal OS outputted to the load 13.

Similarly, the compensation database CD may be created via a pre-measurement process; for instance, a user may use a multi-meter, or the like, to measure the errors of the output signal OS of the converter 12 under different input power signals IS so as to calculate the compensation signals CS corresponding to the errors of the output signal OS of the converter 12 under different input power signals IS, and then create the compensation database CD; next, the user may input the compensation database CD into the compensation control module 111 via the compensation control port 111. When the pre-calibration process is performed, the compensation control module 111 may select the compensation signal CS corresponding to the feedback signal FS2 from the compensation database CD so as to compensate the error.

The difference between the embodiment and the previous embodiment is that the compensation control circuit 11 of the embodiment may directly receive the compensation signal FS2 from the power source 14 instead of receiving a compensation signal from the secondary side of a transformer in real time, just like the conventional compensation control module; therefore, when the power supply is in operation, the compensation control module 111 may directly generate the corresponding compensation signal CS according to the compensation database CD without the need to receive a feedback signal in real time.

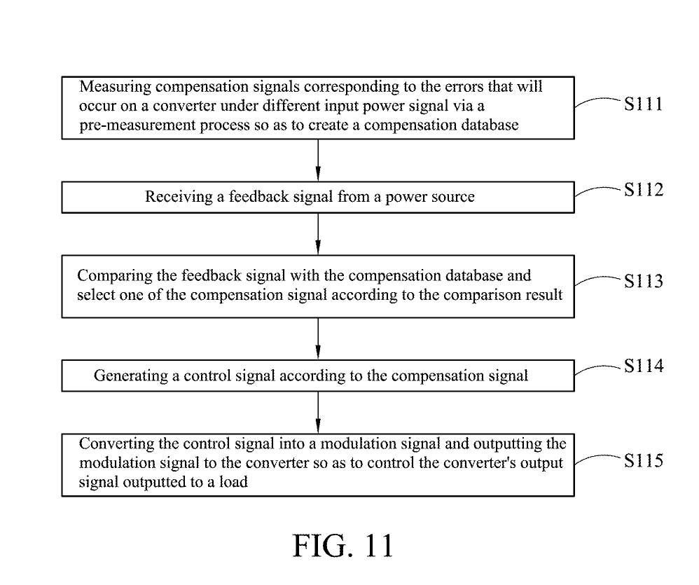

Please refer to FIG. 11, which is a flowchart view of a third embodiment of a compensation control circuit in accordance with the present disclosure. The embodiment may include the following steps:

In the step S111: measuring compensation signals corresponding to the errors that will occur on a converter under different input power signal via a pre-measurement process so as to create a compensation database.

In the step S112: receiving a feedback signal from a power source.

In the step S113: comparing the feedback signal with the compensation database and select one of the compensation signal according to the comparison result.

In the step S114: generating a control signal according to the compensation signal.

In the step S115: converting the control signal into a modulation signal and outputting the modulation signal to the converter so as to control the converter's output signal outputted to a load.

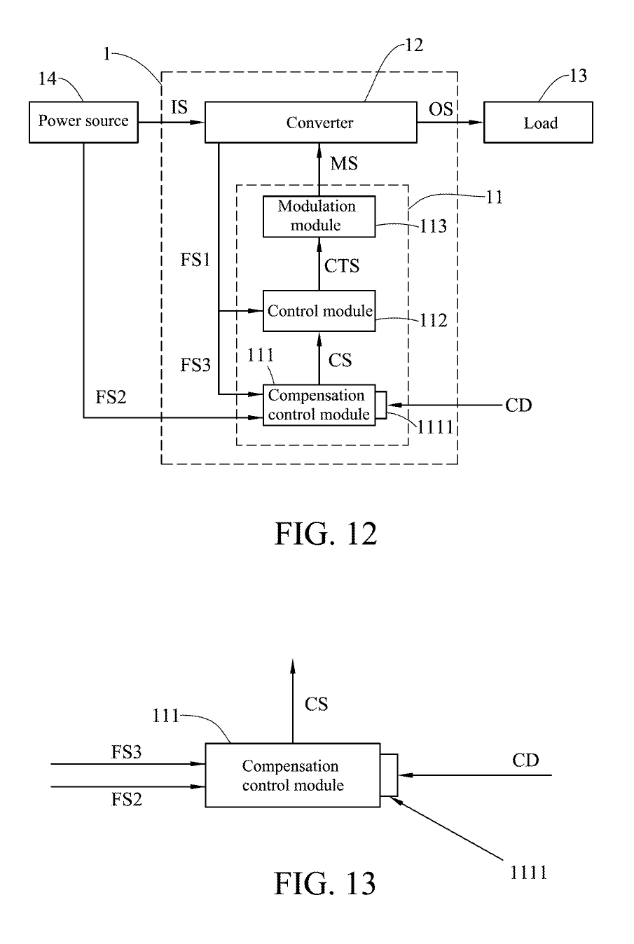

Please refer to FIG. 12 and FIG. 13, which are a first schematic view and a second schematic view of a fourth embodiment of a compensation control circuit in accordance with the present disclosure. For the purpose of further increasing the precision of the compensation control circuit 11, the compensation control circuit 11 may calibrate the error via more than one feedback signal. As shown in FIG. 12, the power supply 1 may include a compensation control circuit 11 and a converter 12; the compensation control circuit 11 may include a compensation control module 111, a control module 112 and a modulation module 113.

The converter 12 may convert the input power signal IS of a power source 14 into an output signal OS and then output the output signal OS to a load 13. As shown in FIG. 13, the compensation control module 111 may include a compensation control port 1111; the compensation control module 111 may receive feedback signals FS2, FS3 from a power source 14 and receive a compensation database CD via the compensation control port 1111; the compensation control module 111 may compare the feedback signals FS2, FS3 with the compensation database CD and output a compensation signal CS according to the comparison result. As shown in FIG. 12, the control module 112 may output a control signal CTS according to the compensation signal CS and a feedback signal FS1. The modulation module 113 may convert the control signal CTS into a modulation signal MS and output the modulation signal MS to the converter 12 so as to control the converter 12's output signal OS outputted to the load 13.

According to the above embodiments, all products can be accurately calibrated via the above pre-calibration process before being used in order to compensate for the errors of the output signals of the products; in this way, the performance of all products can be significantly improved when being used. Besides, according to the embodiments of the present disclosure, the compensation control circuit can not only compensate for the error of the converter without feedback signal, but also can, if the precision needs to be further increased, compensate for the error of the converter via one or more than one feedback signal so as to further improve the performance of the compensation control circuit; therefore, the compensation control circuit is more practical in use.

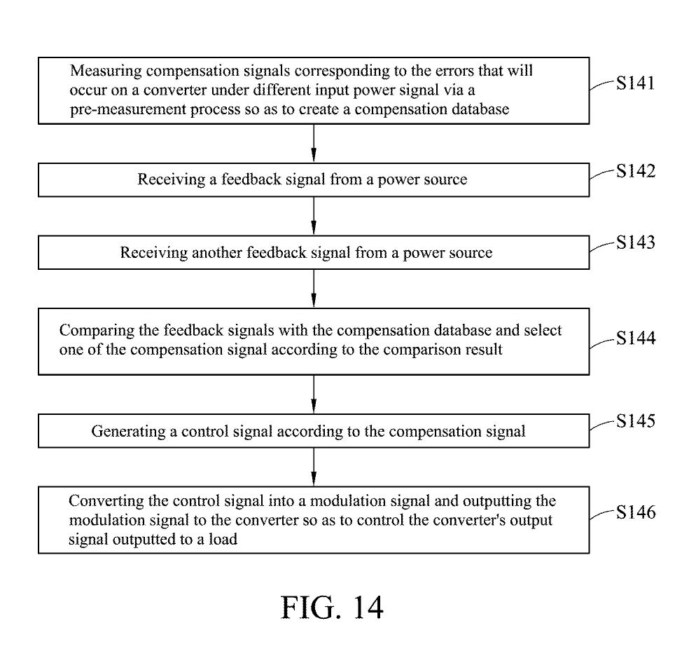

Please refer to FIG. 14, which is a flowchart view of a fourth embodiment of a compensation control circuit in accordance with the present disclosure. The embodiment may include the following steps:

In the step S141: measuring compensation signals corresponding to the errors that will occur on a converter under different input power signal via a pre-measurement process so as to create a compensation database.

In the step S142: receiving a feedback signal from a power source.

In the step S143: receiving another feedback signal from a power source.

In the step S144: comparing the feedback signals with the compensation database and select one of the compensation signal according to the comparison result.

In the step S145: generating a control signal according to the compensation signal.

In the step S146: converting the control signal into a modulation signal and outputting the modulation signal to the converter so as to control the converter's output signal outputted to a load.

In summation of the description above, according to one embodiment of the present disclosure, the compensation control circuit can obtain the compensation signal needed by the converter under a specific input power signal via the compensation database created by the pre-measurement process, which can accurately compensate for the error of the converter; therefore, the performance of the compensation control circuit can be significantly improved.

According to one embodiment of the present disclosure, the compensation control circuit can compensate for the error of the converter in advance via the pre-calibration process, so the compensation control circuit does not need to receive a feedback signal; therefore, the compensation control circuit does not need additional detection circuit and feedback circuit, which can significantly reduce the cost of the compensation control circuit.

According to one embodiment of the present disclosure, the compensation control circuit can generate various output signal waveforms, so the compensation control circuit can satisfy the requirements of various special applications; thus, the application of the compensation control circuit is more comprehensive.

According to one embodiment of the present disclosure, the compensation control circuit can obtain the compensation signals needed by the converter under different input power signals via the compensation database created by the pre-measurement process, and compare the feedback signal of the power supply with the compensation database to generate the corresponding compensation signal by the pre-calculation process; in this way, the compensation control circuit can more precisely compensate for the error of the converter; therefore, the compensation control circuit is more practical in use.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A compensation control circuit, comprising:
a compensation control module, comprising a compensation control port; the compensation control module configured to receive a feedback signal and receive a compensation database via the compensation control port so as to compare the feedback signal with the compensation database and then output a compensation signal corresponding to the feedback signal according to a comparison result;
a control module, configured to output a control signal according to the compensation signal; and
a modulation module, configured to convert the control signal into a modulation signal, and output the modulation signal to a converter so as to control the converter's output signal outputted to a load.

2. The compensation control circuit of claim 1, wherein the compensation control module receives the feedback signal from a power source and the converter.

3. The compensation control circuit of claim 1, wherein the compensation database is created by a pre-measurement process; the compensation database comprises the compensation signals corresponding to errors that will occur on the converter under different input power signals.

4. The compensation control circuit of claim 1, wherein the converter is an isolated converter and the modulation module is a pulse width modulation controller; the compensation control port is a RS232 port.

5. The compensation control circuit of claim 1, wherein a mode of the output signal is a constant-current output mode, a constant-voltage output mode, a constant-power output mode, an irregular-current output mode, an irregular-voltage output mode or an irregular-power output mode.

6. A compensation control method, comprising the following steps:
creating a compensation database;
receiving a feedback signal;
comparing the feedback signal with the compensation database to generate a compensation signal corresponding to the feedback signal according to a comparison result;
generating a control signal according to the compensation signal; and
converting the control signal into a modulation signal, and outputting the modulation signal to a converter so as to control the converter's output signal outputted to a load.

7. The compensation control method of claim 6, further comprising the following step:
receiving the feedback signal from a power source; and
receiving the feedback signal from the converter.

8. The compensation control method of claim 6, further comprising the following step:
measuring the compensation signals corresponding to errors that will occur on the converter under different input power signals by a pre-measurement process so as to create the compensation database.

9. The compensation control method of claim 6, further comprising the following step:
controlling a mode of the output signal to be a constant-current output mode, a constant-voltage output mode, a constant-power output mode, an irregular-current output mode, an irregular-voltage output mode or an irregular-power output mode via the modulation signal.

10. A compensation control circuit, comprising:
a compensation control module, comprising a compensation control port; the compensation control module configured to receive a compensation database via the compensation control port so as to output a compensation signal according to a comparison result;
a control module, configured to output a control signal according to the compensation signal; and
a modulation module, configured to convert the control signal into a modulation signal, and output the modulation signal to a converter so as to control the converter's output signal outputted to a load.

11. The compensation control circuit of claim 10, wherein the compensation database is created by a pre-measurement process; the compensation database comprises the compensation signal corresponding to an error that will occur on the converter under a specific input power signal.

12. The compensation control circuit of claim 10, wherein the compensation database comprises a setting value, and the compensation database generates the compensation signal corresponding to the setting value so as to adjust the output signal of the converter to be close to a pre-determined specification value.

13. The compensation control circuit of claim 12, wherein the compensation database further comprises a compensation value, and the compensation value is measured via a pre-measurement process; the compensation control module regenerates the compensation signal corresponding to the compensation value so as to compensate an error between the output signal of the converter and the pre-determined specification value.

14. The compensation control circuit of claim 10, wherein the converter is an isolated converter; the modulation module is a pulse width modulation controller; the compensation control port is a RS232 port.

15. The compensation control circuit of claim 10 wherein a mode of the output signal is a constant-current output mode, a constant-voltage output mode, a constant-power output mode, an irregular-current output mode, an irregular-voltage output mode or an irregular-power output mode.

16. A compensation control method, comprising the following steps:
creating a compensation database;
generating a compensation signal according to the compensation database;
generating a control signal according to the compensation signal; and
converting the control signal into a modulation signal, and outputting the modulation signal to a converter so as to control the converter's output signal outputted to a load.

17. The compensation control method of claim 16, further comprising the following step:
measuring the compensation signal corresponding to an error that will occur on the converter under a specific input power signal via a pre-measurement process so as to create the compensation database.

18. The compensation control method of claim 16, further comprising the following step:
generating the compensation signal corresponding to a setting value of the compensation database so as to adjust the output signal of the converter to be close to a pre-determined specification value.

19. The compensation control method of claim 18, further comprising the following step:
measuring an error between the output signal of the converter and the pre-determined specification value so as to create a compensation value in the compensation database, and regenerating the compensation signal corresponding to the compensation value so as to compensate the error between the output signal of the converter and the pre-determined specification value.

20. The compensation control method of claim 16, further comprising the following step:
controlling a mode of the output signal to be a constant-current output mode, a constant-voltage output mode, a constant-power output mode, an irregular-current output mode, an irregular-voltage output mode or an irregular-power output mode via the modulation signal.
